(19) United States
(12) Patent Application Publication
(10) Pub. No.: US 2003/0134668 A1
(43) Pub. Date: Jul. 17, 2003

(54) Alternative energy charger for cellular usage

(76) Inventor: Demelash Mekuria, Atlanta, GA (US)

Correspondence Address: Demelash Mekuria, 409 Windmont Drive, Atlanta, GA, 30329, US

(21) Appl. No.: 10/047,773

(22) Filed: Jan. 14, 2002

(51) Int. Cl. H04M 1/00

(52) U.S. Cl. 455/572; 455/574

(57) ABSTRACT

A cellular unit (20A) that obtains its current source directly or indirectly from a light source. The light source is transferred to the unit via transparent panels (20B or 22C) on the cover of the cell phone. The light source is then change from light energy to electrical via a photovoltaic strip or film (20C or 22D). After the conversion to electrical energy, the energy is passed via wires or conductive unit (22E) to the battery (22F) or cell phone unit (20D) depending on the type of unit used. The 2 units embodied in this particular patent are the units utilizing a battery (22A) and the one transferring energy directly (20A). After the energy is transferred it is sent for consumption or storage (22F) for the user of the unit.

### CROSS-REFERENCE TO APPLICATIONS

The application provided in this patent can be applied to any type of battery or unit that is used on the outside. The application in this patent more specifically is applied to cell-phone batteries however it can be applied to other electrical portable devices that are used with a battery that can be charged again. More patents will be pursued pending the success of the 1st.

1. Background-Field of the Invention

This invention relates to cellular-batteries or units and alternative forms for charging them.

2. Background-Description of Prior Art

The prior method of charging cellular phones or any device that is portable is to use a connection to an AC voltage source such as a cigarette lighter or an AC outlet. Such methods of recharging a cellular battery are used daily by holders of cell-phones. Basically it extends the life of the battery connected to the phone by connecting it to an alternate-charging source as an AC outlet or cigar lighter in the car.

The method of connecting the cell-battery to an alternate energy source via cord is a common standard used and addresses the need of using the cell phone consistently without replacing or charging the battery. This patent is used to address and improve the tedious need of users to have to connect their phones to an alternate energy source. The prior method can be time-consuming and may interrupt important calls if per say the battery needs charging in an important time of communication.

The prior method was built up because cell-phones were commonly used in cars. Electrical devices used in cars were normally powered/charged via the cigar lighter. Today cell phones are more commonly used everywhere beside the car and home. People used the cell-phone in the grocery store, the mall, outside in the park or walking to a business meeting in a crowded city. The prior method doesn't address the need for the cell phone to be charged outside of an electrical power source such as a car or AC outlet. What about using the cell phones in a camping situation? What if the battery runs low in an emergency situation where power is not available (such as a blackout or extended power interruption)?

The previous concept also shows a degree of inconvenience as it uses other accessories such as a cord or base that needs consistent charging like an animal that needs consistent feeding. The proposed idea in this patent gives a solution for constantly connecting the battery or phone to an alternative device outside of the cellular unit. It also improves upon the convenience of the cellular phone by utilizing lifestyles of the carriers of the phone to charging the battery.

### SUMMARY

An alternative method to charging a cell-phone with a higher degree of convenience, considering the many areas of use, can be in utilizing solar energy or light to charge the battery. Along with using the solar energy to charging the battery, the solar energy conversion unit can also be placed alongside the battery to keep the battery charged consistently without the need for other separate units.

### OBJECTS AND ADVANTAGES

Accordingly, several objects and advantages of my invention are the convenience and ease of use of charging along with a continuous supply of energy to the battery or phone dependent upon location. As cell phones are used commonly in lighted areas taking advantage of the light supplied will increase the perpetual charging of the batteries. The ease of use or convenience stems from, as shown in the design, the portable nature of the charger and its compatibility with the battery and phone. There may no longer be a need for complex and unreliable accessories as a cigar adapter or a power unit/base. The solar power unit, attached to the battery or in any other location can take advantage of light source anywhere (i.e. the park, the grocery store, the mall or even the restroom). The convenience of having the charging source attached to the phones may also help in carrying situations, where using the prior methods, may have been clumsy or haphazard to charge (i.e. driving a car or in a mall).

Continuous charging dependent upon light source may also be of great use as it may limit the interruptions or need for charging the cell-phone battery. As human beings conduct most business in some type of lighted area, it takes advantages of the location or habits of individuals and uses it to conduct a continuous charge of energy. This will limit the time needed for the phone to be on a base or charger to little or none. Continuous charging means continuous use. The battery may also have a method that stores unneeded energy for use later on. By taking advantage of the region or location of a lighted area it may cause for prior chargers with accessories to become obsolete eventually. Further objects and advantages of the invention will become apparent from a consideration of the drawings and ensuing description.

### DRAWING DESCRIPTIONS

In the drawings, closely related figures have the same number but different alphabetic suffixes.

FIG. 20A represents a direct connection from light to energy with no battery needed for storage. This figure represents the alternative to battery storage. 20B represents the transparent panels which makes light conducive for absorption.

FIG. 22A represents the conversion of light to energy for battery charging instead of a direct method. This will give the advantage of having some current whether there is no light available or not.

FIG. 22B is where the energy is transferred from the battery to the phone, FIG. 22C represents the transparent panels conducive to light in order to make the conversions from light source to electrical.

FIG. 22D represents the photovoltaic strip that will be used to convert light energy to electrical.

FIG. 22E represents the connection from the photovoltaic strip to the battery unit.

FIG. 22F represents the battery unit.

In an outline format the figures are as follows:

20a Built in panel without batteries

b. Transparent panel

c. Photovoltaic strip for energy conversion

d. Cell phone-operating unit

e. Cell phone dialing cover

22a. Battery unit

b. Energy transfer to cell phone

c. Transparent panel

d. Photovoltaic unit

e. Connection unit to transfer electrical charge

f. Battery unit

### DESCRIPTION OF INVENTION

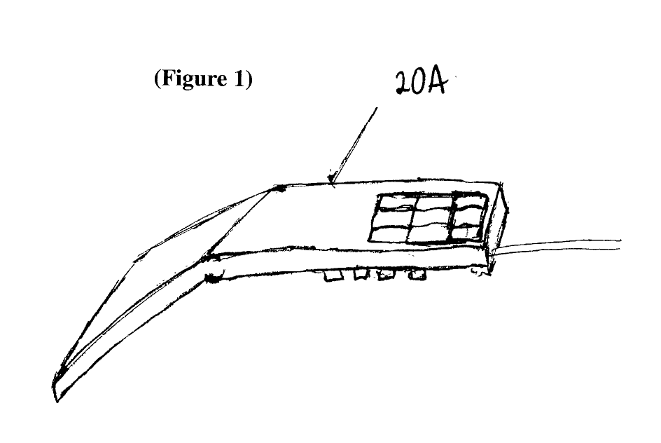

FIG. 20 shows a perspective view of a basic unit bypassing the battery unit. FIG. 20A is the overall unit itself as a whole. Object 20B is the transparent panel conducive for light absorption. It can be made of any material provided that the material is transparent and conducive for light absorption. Object 20C is the most import part of the invention, the photovoltaic strip. The photovoltaic strip usually consists of solar cells that transform light energy into electrical. Any unit that accomplishes this conversion can be referred to as the photovoltaic strip. FIG. 20D is the cell phone-operating unit. It consists of the basic parts of a cell phone or cordless phone that is in use today. It is not describe in detail as it is already invented. FIG. 20E is the cell phone outside front cover that may have many of the features of the cell-phones in use today.

### OPERATION OF INVENTION

The figure shown for 20(A-E) shows a perspective view of a basic simplified version of a direct method for energy bypassing the battery unit. The main parts are the transparent panel to make light conversion conducive, the photovoltaic strip that transforms light energy to electrical, the cell phone unit which composes of the workings of a typical standard cell phone and the dialing unit. These parts interconnect to form a cell phone powered directly by light.

For device represented by 20A, the back panel first is layered with a transparent strip (20B) that can range from any shape and size that allows light to enter into the unit as a whole. It can be any color or shade as long as it makes light absorption conducive. This figure is layered on top of the photovoltaic strip (20C) that converts light energy into electrical. The strip can be any dimension but for practical reasons it should match the dimensions of the transparent panel (20B) to make optimum use of the light source provided. Once this energy is converted to electrical charge there are 2 connections in the cell phone unit that are used to transfer the electrical charge from the photovoltaic strip to the cell phone unit (20D). Many methods can be used to transfer the charge to the cell phone unit than the one depicted in the drawing however the bottom-line is that current is transferred to the cell phone unit (20D) which comprises the standard operating units used in most cell phones today. After the current is transferred the voltage can be used for basic dialing operations and features that may access through the front panel (20E). The unit as a whole doesn't need a battery device but feeds directly from the light source.

### DESCRIPTION AND OPERATION OF ALTERNATE EMBODIMENTS

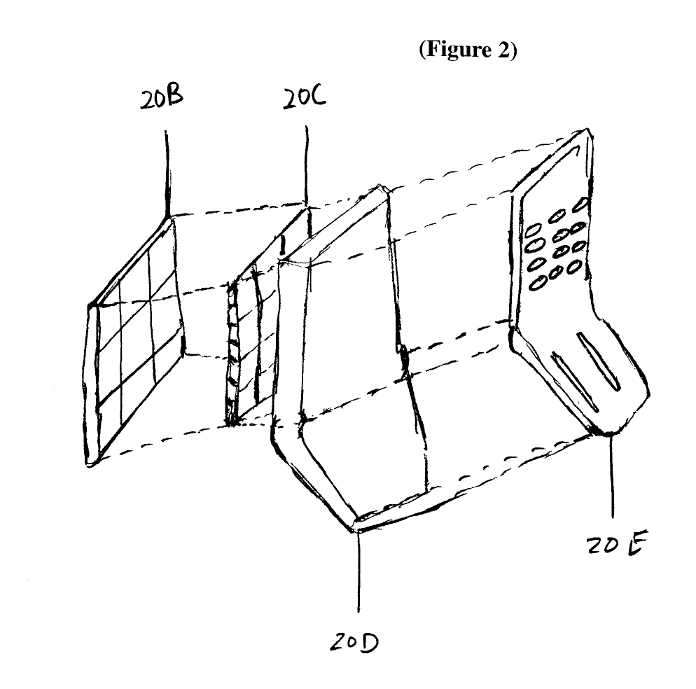

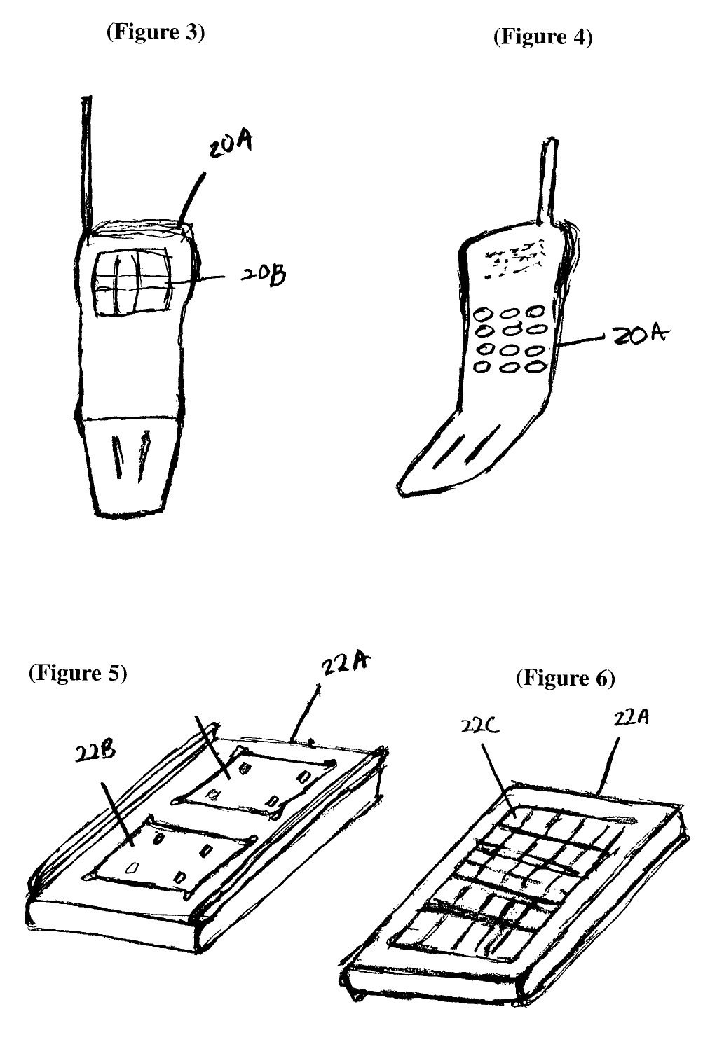

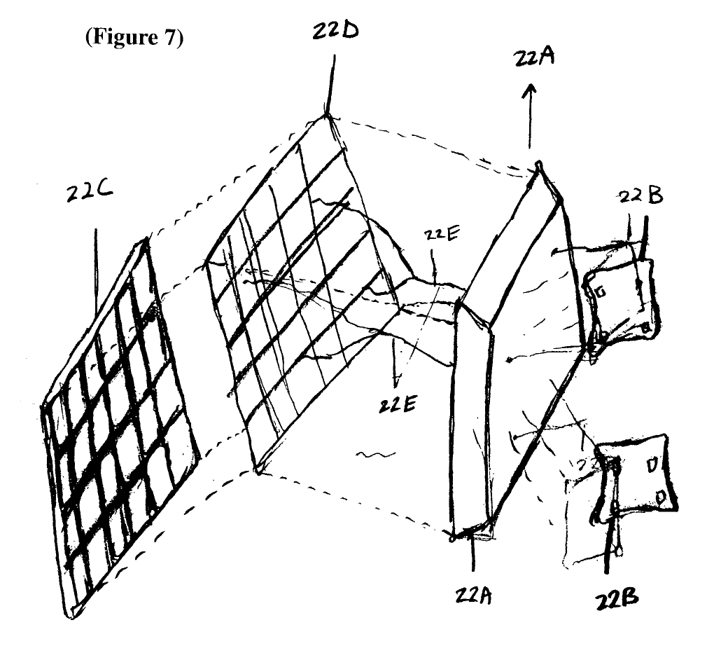

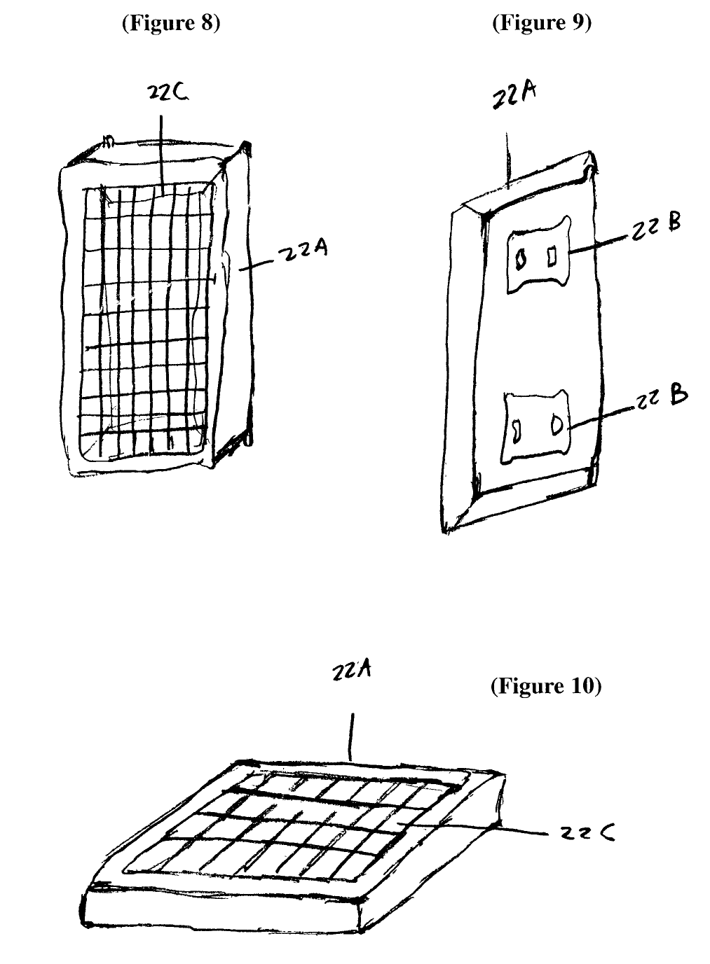

For FIG. 22A is showing the battery unit as a whole that may be attached to the cell-phone or any other relevant unit used in light. FIG. 22B is the conductive units used in electrical charge transfer. It can be made out of several metals that have a good conductive capability (aluminum, copper, steel, etc). FIG. 22B is already in use today and comes in many forms. Placement of it is not important but function. FIG. 22C is the transparent panels used for light absorption. It can be made of any material provided that it is conducive for light absorption. FIG. 22D is the photovoltaic strip used for converting light energy to electrical via solar cells. It's shape and size can vary but generally should match the shape and size of the transparent panels. FIG. 22E is the connection between the photovoltaic strip and the battery unit. It can be made up of any material that will take the current/charge away from the photovoltaic strip to the battery unit. In the case of the drawings it is simply 2 wires connecting the photovoltaic strip to the battery unit. FIG. 22F is the battery itself that can receive charge for storage for 22E.

The device shown by 22A is an indirect method of light conversion with an intermediate connection of a battery for power storage. This device, starting with 22C, is a transparent layer that is conducive for light absorption. The light is absorbed by the panels and is sent to the photovoltaic strip (22D). This strip takes light energy and converts it to electrical. The photovoltaic strip (22D) then sends the charge via a connection to the standard battery unit (22F) which uses the electric current for charge or as needed depending on the user. The electrical charge will be sent to the battery unit (22F) ultimately and this can be achieved through various methods. The method in the drawing shows 2 wires connecting the photovoltaic strip to the battery unit. Once the charge is carried to the battery unit it can be used for consumption to the cell phone through the conductor panels (22B) to the cell phone units or any unit needed by the battery. In summary, this is an indirect method for using light exposure to power a cell phone through the intermediate device of the battery unit for energy storage.

### CONCLUSION, RAMIFICATION AND SCOPE

Thus the reader will see that both units utilize light energy to power, directly or indirectly, the cell phone unit and is highly more convenient and will allow for continuous use of the phone without constant need for charging through units or bases. This allows the user more freedom in usage concerning location and conversation.

While the above descriptions contains various specifications these should not be construed as limitations on the scope of the invention, but rather as an example of 2 preferred embodiments in the form of a accessories or attachments to the cell-phone. Many other variations are possible, for example the battery need not power just a cell-phone but perhaps a camcorder or a walkie talkie device. The pieces that composed the unit may also vary in shape and size as long as they achieve their perspective function. For example, the transparent panels may be one strip along the back cover or it can compose of the whole front panel of the cell phone. The photovoltaic strip can also vary and may not need to match the transparent panels however for design sake shown in both embodiments it is more reasonable that they match and cover the same planar area. Thus the scope of the claim should be determined by the appended claim and it's legal equivalents.

I claim:

1. A communication unit that obtains at least part of its voltage or current source, indirectly or directly, through light energy through the use of:
a.) A unit for converting solar energy to electrical directly
b.) A unit for converting solar energy to electrical charge for storage in a battery device.
